(19) United States
(12) Patent Application Publication
(10) Pub. No.: US 2014/0284332 A1
(43) Pub. Date: Sep. 25, 2014

(54) Toppless Trash Can

(71) Applicant: Theodore Bryan Parker, Gwynn Oak, MD (US)

(72) Inventor: Theodore Bryan Parker, Gwynn Oak, MD (US)

(21) Appl. No.: 13/848,548

(22) Filed: Mar. 21, 2013

(51) Int. Cl. B65F 1/12; B65F 1/14

(52) U.S. Cl. CPC B65F 1/12; B65F 1/1623
USPC 220/262

(57) ABSTRACT

The Topless Trash Can is a durable, temper resistant receptacle that includes a Shade made of clear rubber plastic. The Shade has an embedded mesh interior to keep out intruders. The unit also has a Handle for hand-free lifting and emptying by municipal devices.

### CROSS-REFERENCE

Prior Application Filed Information as Follows . . .

Inventor: Theodore Bryan Parker

Title: Topless Can

Provisional Application No. 61/634,614

Status: Pending

Filing Date: May 3, 2012

### DESCRIPTION OF DRAWINGS

FIG. 1 shows the Handle for lifting by municipal devices.

FIG. 2 shows the Spring-Loaded Rubber Top (with embedded mesh interior) that retracts within the unit.

FIG. 3 shows the Hook that holds the Top Handle in place.

FIG. 4 shows the Chain that releases the Top Hook.

FIG. 5 shows the Release Bar that releases the Shade (Top).

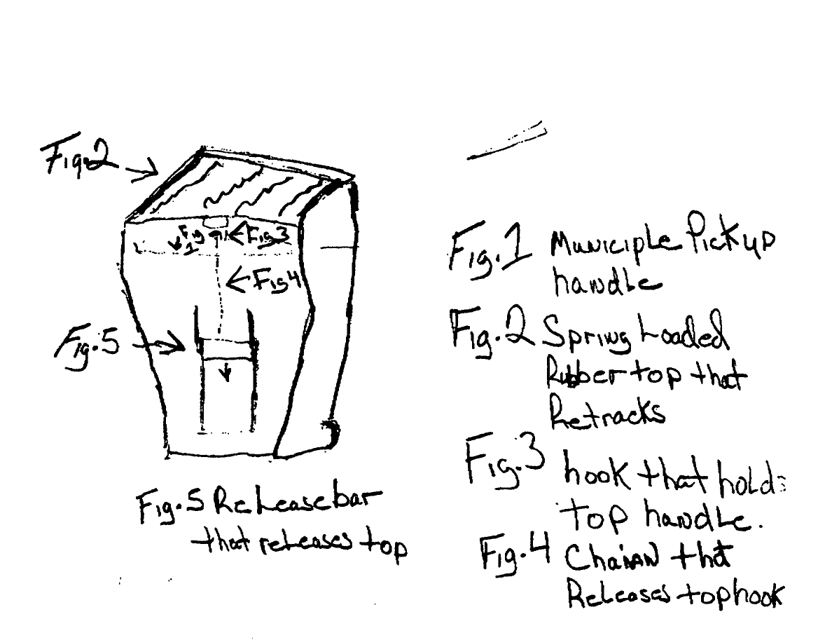

### DETAILED DESCRIPTION OF TOPLESS TRASH CAN

GENERAL: The “Topless Trash Can” is a tamper-resistant receptacle that includes special features that makes it efficient, cost-effective, and unique. In summary, the Topless Trash Can has parts that are durable and sturdy. The unit includes detachable parts that are sold separately to promote low-product replacement costs and high savings. The unit incorporates a Shade that is retractable and made of hard rubber. The base of the Topless Trash Can has corners that have a wire-mesh material built into its sides to prevent breakage and access by intruders, and includes a Release Bar that permits hands-free disposal of contents.

One of the many advantages over current products on the market is that parts can be purchased unilaterally. Unit costs, therefore, remain low due to the fact that parts can be purchased as needed, and customers are not required to purchase all parts of the unit simply to acquire a “missing part” of a “set” or “complete trashcan”, and furthermore, there is no loss of value to parts already on hand.

### Parts of the Topless Trash Can Include, as Shown in Drawings:

The Figure shows the entire Trash Can is shown with parts identified, as follows.

1. Detachable, Retractable Shade, with Screen, as seen on FIG. 2
a. FIG. 2 is a drawing of Shade; vertical lines depict the rubber shade. The shade is constructed of ⅔ inch hard rubber and the base of the Trash Can has 8″×10″ wire-mesh patches at the front two corners that resist puncture, breakage, animal bites, and gnawing, and external interfaces.
b. The “shade” is structured as a mechanism that “rolls-backs” or “retracts” within the unit; prevents access from foreign objects, animals, intruders, or other external forces; and deters and prevents spillage and/or access to contents within the can.
c. The rubber shade is protected within the hard plastic corners of the unit and overlay; additionally, the shade and the wire-mesh patches all prevent animals cannot chew or gnaw through.
d. The shade can be manually activated to retract and attached to the Topless Trash Can by pins to plastic Hooks (FIG. 3), which are built into the parameter of the top rim of the unit.
e. The shade is detachable, can be replaced, and can be sold separately from the base Topless Trashcan.
f. if the rubber Shade of Trash Can “bottom” is lost, stolen, or destroyed, the Shade and Trash Can are still complete units and useful to the owner.
   1. The owner need only replace the part needed, and not purchase the part that he/she already has in possession.
   2. This eliminates purchasing unwanted, unneeded units repeated, which can be costly over time.
   3. Unit costs will remain low due to the fact that parts can be purchased separately, as needed, with no loss to value to parts on hand.
   4. This is unique to other trash cans currently sold on the market, as stores do not allow consumers to purchase trashcan tops or bottoms unilaterally. The customer must buy “complete units”. If he/she requires only a lid or just a trashcan base, he/she must buy the complete trashcan at full price, with no savings or discounts allotted. The current “pieces” the consumer has in possession become useless and devalued.
   5. Overtime, this can be extremely costly, as trashcan parts are often lost, stolen, damaged, or blown away by wind or external forces, beyond a consumer's control.
   6. Conversely, the Topless Trash Can eliminates the need to purchase unwanted parts repeatedly; the consumer need only purchase the desired part(s), thereby retaining value and increasing savings.*

### 2. The Topless Trash Can Includes Handles for Lifting Unit (FIG. 3); and a Hook (FIG. 3) and Chain (FIG. 4) for Attaching Shade Manually:

The Handle and Release Bar (FIG. 5) is shown, which allows the unit to be emptied mechanically by municipal vehicles, other

1-3. (canceled)

4. The shade closure of the topless trash can is a rubber top that retracts into the rear of the can by gliding along tracks located on the sides and rear of the unit. A locking mechanism secures the shade closure in place when closed and is opened only when the release bar is activated. The release bar is located in the front, bottom center of the unit and inset so that it is flush with the front of the unit. A chain attaches the release bar to the locking mechanism. Downward pressure applied to the release bar opens the locking mechanism allowing the shade closure to retract into the back of the can.
